(19) United States
(12) Patent Application Publication
(10) Pub. No.: US 2011/0217595 A1
(43) Pub. Date: Sep. 8, 2011

(54) SEPARATION LAYER FOR SEPARATING ANODE AND CATHODE IN LITHIUM ION ACCUMULATORS OR BATTERIES

(75) Inventors: Alfons Kelnberger, Bamberg (DE); Hans-Jürgen Schreiner, Neunkirchen am Sand-Rollhofen (DE)

(73) Assignee: CERAMTEC GMBH, Plochingen (DE)

(21) Appl. No.: 13/126,187

(22) PCT Filed: Oct. 29, 2009
(86) PCT No.: PCT/EP2009/064266

§ 371 Date: Apr. 27, 2011

(30) Foreign Application Priority Data
Oct. 29, 2008 (DE) 10 2008 043 272.5

(51) Int. Cl. H01M 2/16; C08J 5/22

(52) U.S. Cl. 429/248; 521/27

(57) ABSTRACT

Electronic short-circuiting between the anode and cathode in Li ion accumulators or batteries, an electronic separate of anode must be present with minimum electronic conductivity. To this end, in general a separating layer in the form of porous films, non-woven fabrics or nets made of polypropylene or similar polymers and containing Li ion-conducting salts and ceramic particles is used. Disadvantages of the known separating layers are the low thermal resistance and thereby embodiments with a high energy content, expensive manufacturing processes and complex interaction of the chemical substances used in the separating layers.

The invention relates to a separating layer (separator) for separating the anode and cathode in lithium-ion accumulators or batteries and also to a method for its production.

Separating layers in the form of porous foils, non-woven fabrics or nets made from polypropylene or similar polymers and also ceramic separating layers (commercial name “Separion”), as they are known, for example, from DE 102 55 122 A1, that contain salts conducting Li-ions constitute current prior art.

The demands made on such a separating layer are high:
In order to avoid electronic short-circuiting between the anode and cathode there must be electronic separation of the anode and cathode with minimum electronic conductivity.
Guarantee of a high level of ion-conductivity, in particular for Li-ions, and a low internal resistance connected therewith of the accumulators and batteries realized therewith.
High thermal conductivity to dissipate the heat that develops during operation of the accumulators and batteries.
Shut-down function in the case of an overload to maintain the basic function and increase the general operational safety, in particular for large-volume applications, for example in the field of motor vehicles.
Absolute freedom from water and no undesirable reactions between the individual substances.

The disadvantages of the known separating layers are the low thermal loading capacity and, conditional thereon, low operational safety, in particular in the case of large-volume embodiments with a high energy content, elaborate production processes and also complex interactions of the chemical substances that are used in the separating layers.

In particular, in the case of the ceramic separating layers (separators) a plurality of process seeps and the cooperation or a complex chemistry are necessary in order to achieve the desired properties with regard to the physical, electrical and chemical parameters. The basic principle of this known solution is that of applying to a polymer foil, such as polyester, polyacrylonitrile or polyolefines, as a mechanical basic framework a ceramic slip, for example of Al₂O₃ or SiO₂, the adhesive strength of which must be increased by adding adhesion promoters, such as, for example, silanes. The ceramic particles then act more or less as spacers between the anode and the cathode in the accumulator or battery composite and as heat-conductors ensure that there is dissipation of the thermal energy. In addition, shut-down layers made from waxes, low-melting-point polymers and the like are applied which in the case of overloading close the pores of the highly porous foil and thus prevent a burn-up of an accumulator or a battery. This complex, porous composite of polymer foil, ceramic slip, adhesion promoters and shut-down particles is then used as a carrier material for the salts conducting Li-ions, such as, for example, LIPF₆ or LiBOB, which in turn must be dissolved in low-melting-point ionic. Liquids. The carrier foil must then be completely saturated and wetted with this salt solution in a further step and only then are the desired properties achieved.

An object of the invention is to provide a separating layer (separator) which eliminates the existing disadvantages of the current prior art. In particular, given at least the same capacity of the accumulator or the battery a separating layer is to be provided that is more compact and substantially easier to produce than the separating layers that consist of polypropylene or similar polymers or are based thereon.

The object is achieved in accordance with the invention by means of a separating layer consisting of a foil based on an organic matrix of polymers or polymer-like substances according to claim 1 and also by means of a method for producing such a foil according to claim 15. Advantageous developments of the invention are claimed in the dependent claims.

The invention consists of a novel separating layer (separator) based on an organic slip solution for the separation of the anode and the cathode in Li-ion accumulators or batteries.

In order to produce the separating layer in accordance with the invention, in the first instance so-called binders are dissolved in organic solvents, and a so-called pre-slip is produced by means of suitable mixing processes, for example in dissolvers, jet mixers or mills.

Advantageously, polymers or polymer-like substances are used with which the separating layer that is produced therefrom has a high Li-ion-conductivity. These are, for example, polymers from the substance class of the so-called inorganic-organic hybrid polymers, which are also known by the name of Ormocers. These polymers or polymer-like substances are used in a proportion of 0.5% by weight to 30% by weight (quantitative proportion in percent by weight), preferably in a proportion of 1% by weight to 15% by weight.

In addition, the inorganic proportion of these polymers or polymer-like substances that substantially contains a framework of siloxanes ensures that there is high thermal, mechanical and electrochemical stability of the separating layer that is produced therefrom.

It can be helpful to admix with this pre-slip plasticizers known from the prior art, in a proportion of up to 5% by weight, preferably in a proportion of less than 3% by weight, and also dispersing agents in a proportion of up to 5% by weight, preferably in a proportion of less than 3% by weight.

The plasticizers ensure that there is certain flexibility of the subsequent separating layer and the dispersing agents contribute to distributing the constituents of the separating layer uniformly.

Advantageously, so-called shut-down particles are added to this pre-slip in a proportion of up to 30% by weight, preferably in a proportion of up to 10% by weight, that ensure that in the separating layer during subsequent operation in an accumulator or a battery in the case of a thermal overload or in the case of another disturbance, for example a mechanical defect, the function of the separating layer is rendered ineffective locally without thereby putting the function of the accumulator or the battery in general at risk. The size of these particles lies in the order of magnitude of that of the salts or of the ceramic particles, between 0.5 μm and 5 μm, preferably between 1 μm and 3 μm.

The shut-down particles can be waxes or low-melting-point polymers that melt in the event of thermal overload and locally flow around the particles of the foil and eliminate the conduction of the Li-ions or prevent electronic short-circuiting.

As further constituents ceramic powders, for example of Al₂O₃, SiO₂, TiO₂, ZrO₂, AlN or mixtures of the same, are then added to this pre-slip in a proportion of up to 90% by weight, preferably in a proportion of less than 80% by weight. The particle size of these powders lies between 0.01 mm and 10 μm, preferably between 0.5 μm and 5 μm, and is distinguished by a narrow grain-size distribution. As a result of these particle properties, very thin separating layers can be produced in the form of foils of the order of magnitude between 20 μm and 30 μm.

Furthermore, the ceramic particles in the separating layer take over the formation of the framework, thus ensure that there is a defined distance between the anode and cathode and on account of their electrically insulating properties prevent the electronic short-circuiting.

On account of their thermal properties, in particular relatively high thermal conductivity, the ceramic particles ensure, furthermore, that there is an even distribution of the thermal energy that develops during operation of an accumulator or a battery and ensure that the heat is transported away outwards.

Thus accumulators and batteries that are fitted with the separating layers produced in accordance with the invention can be cooled in a very efficient manner.

As the most important addition to the pre-slip solution, in consideration of the proportion of ion-conductive polymers or polymer-like substances, electrolytic salts are required in a proportion from 10% by volume (quantitative proportion in percent by volume) to 50% by volume, preferably in a proportion from 20% by volume to 30% by volume, these being responsible to a considerable extent for the high Li-ion-conductivity.

A plurality of Li-compounds come into consideration as electrolytic salts, for example LiPF₆, LiBF₄, Li-imides Li[N(SO₂CF₃)₂], Li-methides Li[C(SO₂CF₃)₃], LiBOB (lithium bis-(oxalato)borate), LiTFSi.

The particle sizes and the grain-size distribution of the salt particles are of a similar order of magnitude as that of the ceramic particles.

Advantageously, the proportion of the salts and additives that are possibly required should lie above the percolation threshold which, as a function of the particle shape and the proportion of ion-conductive polymers or polymer-like substances, typically lies at 20% by volume to 30% by volume, that is, in order to establish an efficient Li-ion-conduction, the salts should be distributed in the separating layer in a uniform and coherent manner so that a conductive network is formed.

After the addition of the ceramic particles and the salt particles to the pre-solution, the slip must be homogenized, that is, all the constituents should be distributed as uniformly as possible, and this distribution should be maintained in the further process step of foil-casting or foil-drawing.

The homogenization of the slip can be effected by means of standard mixing processes, for example in drum mills with periods of mixing of from a few hours to a few days.

Afterwards, the ceramic particles for the transportation away of the thermal energy and as spacers in order to avoid electronic short-circuiting between the anode and the cathode, the electrolytic salts conducting Li-ions for the guarantee of the Li-ion-conductivity, and also, if applicable, the shut-down particles for locally shutting down the accumulator or the battery in the event of an overload or in the case of a fault are combined together and uniformly distributed in the slip in order to produce the green foil.

The casting slip thus produced can subsequently be either cast or drawn to form a foil by the methods known from the prior art. In the case of foil-casting, the slip in accordance with the invention is homogeneously and uniformly cast out on a carrier band with the aid of a casting shoe and a doctor-blade arrangement and processed in a drying system to form the separating layer in accordance with the invention in the form of a flexible and mechanically stable thin foil of a thickness approximately 20 μm to 30 μm. Drying is effected at temperatures between 60° C. and 120° C. for a period of less than 5 hours. It may not cause the shut-down particles to melt.

What is important is that the layers that are separated by the separating layer cannot interact with each other through pores. The proportion of pores should therefore amount to less than 5% by volume, preferably less than 1% volume, particularly preferably less than 0.1% by volume. The pores should be closed pores and not be larger than 10 μm and not form any pore chains passing through the separating layer. Furthermore, the separating layer should not have any mechanical defects.

Instead of drying, it is also possible to carry out binder-removal, in which case this step and the level of the temperature are determined by the composition of the separating layer, since as a result of this thermal treatment no conversion of a substance may occur in a direction that could put the functioning ability of the battery or the accumulator at risk. The thermal treatment in the case of the removal of binders is effected at temperatures between 200° C. and 500° C. Removal of binders can be carried out without any problems if no shut-down particles are added. Otherwise, the melting point of the shut-down particles must lie above the binder-removal temperature.

The binder-removal is as a rule carried out in the stacked composite with the anode and cathode materials, in which case these likewise may not be destroyed.

In accordance with the invention the separating layer is to contain as few components as possible. During binder-removal, for example, the polymers that are needed to shape the stacked composite anode-separator-cathode—similar to the case of a structure of a piezoceramic multilayer actuator—are removed. The polymers which are contained in the anode and cathode are also removed. The composite is then supported by the remaining components, inter alia the ceramic components and the inorganic proportion of the polymers or polymer-like substances.

The advantages of the present invention over the prior art are as follows:

The porous polymer carrier foil as a starting material can be completely dispensed with, since the constituents that are important for the operation are held together by the organic binder system, possibly up until the binder-removal.

No adhesion promoters that are harmful to health are required to bind the ceramic particles onto the polymer carrier foil, since the ceramic particles are integrated into the green foil in accordance with the invention. The adhesion promoters can thus be dispensed with.

The elaborate process of wetting the carrier foil with the electrolytic salt solutions can be dispensed with, since the electrolytic substances are also integrated into the green foil in accordance with the invention.

The porosity of the foil is not a deciding factor, since the degree of filling with electrolyte is guaranteed by way of the mix of the starting substances and not by way of subsequent wetting.

The separating layer in accordance with the invention is constructed, regarding its geometry and its composition, in such a way that it has high Li-ion-conductivity and thus a low internal resistance; at the same time it is electrically insulating and prevents short-circuiting between the cathode and anode.

The invention is explained in greater detail with the aid of examples. In the drawings:

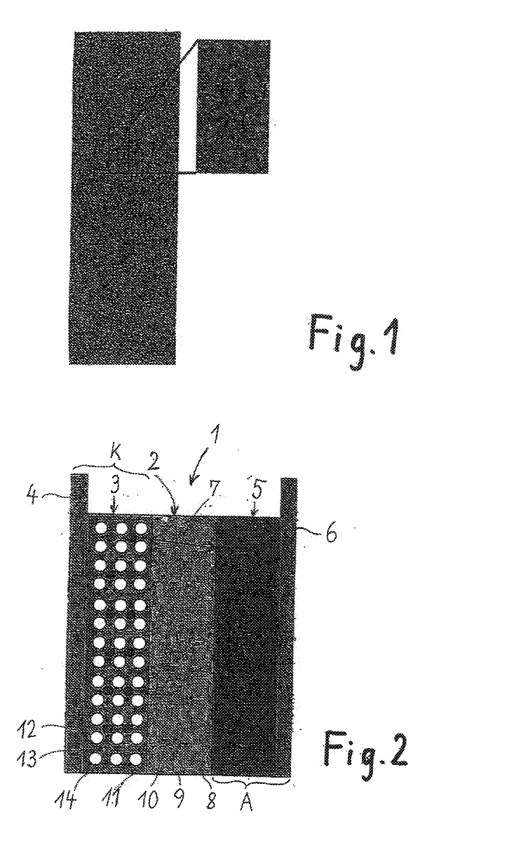

FIG. 1 shows a separating layer in accordance with the invention as a ceramic green foil with a ceramic binder system;

FIG. 2 shows an example of an Li-ion accumulator that is set up with the separating layer in accordance with the invention;

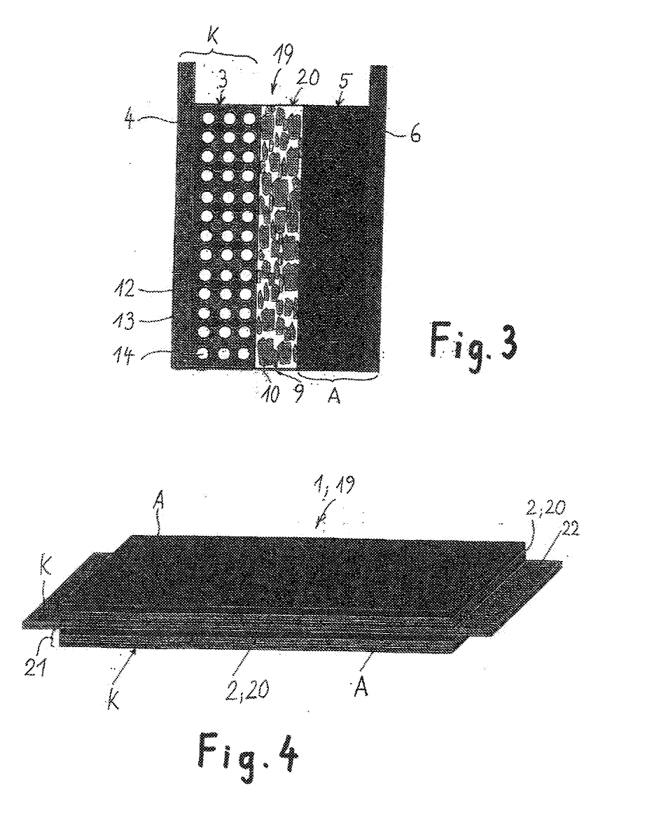

FIG. 3 shows an example of an Li-ion accumulator that is set up with the separating layer in accordance with the invention, where the separating layer has been freed of its organic binder system;

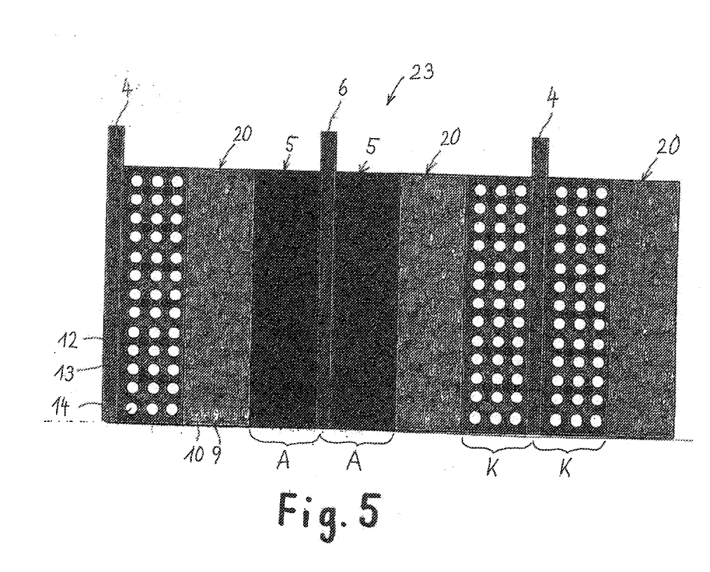

FIG. 4 shows an example of a typical stacked structure, consisting of an anode, cathode, the separating layer in accordance with the invention and a heat-conducting intermediate layer for heat dissipation; and

FIG. 5 shows an example of the structure of an accumulator with an alternating sequence of cathodes and anodes.

FIG. 1 shows a separating layer in accordance with the invention in section as a composite consisting of electrolytic salts, ceramic particles and shut-down particles, embedded in an organic matrix of polymers, which conduct Li-ions, as binders.

The foil has a thickness of 30 μm. In the present case the ceramic particles consist of Al₂O₃ in a proportion of approximately 28% by weight; the particle size lies between 1 μm and 3 μm. The ceramic particles form a framework so that as a result of the dense packing good heat distribution and heat dissipation are guaranteed.

The electrolytic salt LiBOB with high ion-conductivity in a proportion of approximately 35% by weight, lying above the percolation threshold, and a particle size lying between 1 mm and 3 μm is embedded in the framework.

The polymer matrix consists of Ormocers in a proportion of approximately 37% by weight and also the shut-down particles, consisting of a low-meiting-point polymer. The proportion of shut-down particles amounts to approximately 20% by weight of the whole organic fraction.

As can be seen from the enlargement in the representation, there is a narrow grain-size distribution. No adhesion promoter is added.

In FIG. 2 a basic representation of an accumulator 1 with the separating layer 2 in accordance with the invention is shown as an exemplary embodiment. The separating layer 2 is located between a layer 3 which substantially consists of lithium metal oxide and together with the aluminium diverter 4 represents the cathode K of the accumulator 1, and also a layer 5 of graphite which together with the copper diverter 6 represents the anode A. During the charging process the Li-ions migrate through the separating layer 2 in accordance with the invention from the cathode K to the anode A; during the discharging process they migrate in the opposite direction, as indicated by the double arrow 7.

The composition of the separating layer 2 is indicated with the aid of the symbols in it. 8 denotes the polymers into which the ceramic powders 9, the salts 10 conducting Li-ions and also the shut-down particles 11 are embedded.

The layer 3 is composed of a lithium metal oxide, for example of LiNi_{0.85}CO_{0.1}Al_{0.05}O₂, LiNi_{0.33}Co_{0.33}O₂ or LiMn₂O₄. Thus the lithium ion is denoted by 12, the metal ion by 13 and the oxygen ion by 14.

The embodiment of the accumulator 19 in FIG. 3 corresponds with that in FIG. 2 with the exception of the composition of the separating layer 20 in accordance with the invention. Corresponding features are therefore denoted by the same reference numerals. The difference in the composition of the separating layer 20 from that of the separating layer 2 according to FIG. 2 lies in the fact that it does not contain any shut-down particles, and the organic polymers and the organic binder system have been removed during the further accumulator production. This can happen by means of suitable thermal processes within the scope of binder-removal. Since the organic constituents are removed during binder-removal, for a separating layer treated in such a way it is also possible to use binder systems that have less optimum Li-ion-conductivity, but which guarantee instead good mechanical stability of the separating layer. This has the advantage that during the further shaping the separating layer can be handled very easily when setting up an accumulator or a battery.

A typical stack structure of an accumulator or a battery 1; 19 is shown in FIG. 4. The individual packets 21 consisting of the cathode K, the separating layer 2 or 20 in accordance with the invention and the anode A are preferably separated by separating layers 22 with good thermal conductivity. These can have the same composition and the same structure as the other separating layers.

It is possible, furthermore, to install an additional intermediate layer that has high thermal conductivity and consists, for example, purely of ceramic particles or of a composite of ceramic particles and organic binders, such as polymers or polymer-like substances. This additional intermediate layer would not conduct Li-ions and would not perform a separator function, but just a heat-dissipating function.

The heat-dissipating separating layers 22 can be connected, for example, to a ceramic housing or to a material or network that otherwise has good thermal conductivity, by way of which the heat can be dissipated to the environment. However, no contacts giving rise to short-circuiting may result in this case. With this method of construction, very large and compact accumulators or batteries can be realized with a large number of individual packets 21 and high power density, with which the thermal energy can be dissipated outwards in an optimum manner.

FIG. 5 shows by way of example the structure of an accumulator 23 with an alternating sequence of cathodes K and anodes A which are each separated by means of a separating layer 20 and in which the separating layer 20 has in the present exemplary embodiment a composition as shown in FIG. 3. The organic polymers and binders have been removed by means of thermal treatment of the separating layer. Features that correspond with the exemplary embodiment according to FIG. 3 are denoted by the same reference numerals. Of course, a composition of the separating layer with polymers as shown and described in FIG. 2 is also possible.

The alternating stack sequence of the cathode K and anode A, of which only a cutaway portion from a larger sequence is shown here, renders possible optimum utilization of the space in the accumulator 23. Each cathode K consists of the aluminium diverter 4, which is coated on both sides with a layer of lithium metal oxide 3. Each anode A consists of the copper diverter 6 which is coated on both sides with a layer of graphite 5. During the charging process, the Li-ions migrate from the cathode K from the side facing the anode through the separating layer 20 in accordance with the invention to the anode A lying between the cathodes K; during the discharging process they migrate from the anode A on both sides in the opposite direction to the cathode K that is adjacent in each case.

1-24. (canceled)

25. A separating layer for separating the anode and cathode in Li-ion accumulators or batteries, wherein the separating layer comprises a salt conducting Li-ions and ceramic particles, wherein the salts conducting Li-ions and the ceramic particles are embedded in an organic matrix of a polymer or polymer-like substances.

26. A separating layer according to claim 25, wherein the salt amounts, in consideration of the proportion of ion-conductive polymers or polymer-like substance, to 10% by volume (quantitative proportion in percent by volume) to 50% by volume, and lies above the percolation threshold.

27. A separating layer according to claim 25, wherein the particle size of the salt lies between 0.01 mm and 10 μm.

28. A separating layer according to claim 25, wherein the proportion of the salt is from 20% by volume to 30% by volume.

29. A separating layer according to claim 25, wherein the polymer or polymer-like substance amounts to 0.5% by weight to 30% by weight.

30. A separating layer according to claim 25, wherein the ceramic powder comprises at least one member selected from the group consisting of Al₂O₃, SiO₂, TiO₂, ZrO₂ and AlN and mixtures of the same, in a proportion of up to 90% by weight.

31. A separating layer according to claim 30, wherein the particle size of the ceramic powder lies between 0.01 mm and 10 μm.

32. A separating layer according to claim 25, wherein a plasticizer is present in a proportion of up to 5% by weight.

33. A separating layer according to claim 25, wherein a dispersing agent is present in an amount of up to 5% by weight.

34. A separating layer according to claim 25, wherein further comprising shut-down particles in a proportion of up to 30% by weight.

35. A separating layer according to claim 34, wherein the size of the shut-down particles lies between 0.5 μm and 5 μm.

36. A separating layer according to claim 25, wherein its thickness lies between 20 μm and 30 μm.

37. A separating layer according to claim 25, wherein the proportion of pores amounts to less than 5% by volume.

38. A separating layer according to claim 37, wherein the pore size amounts to a maximum of 10 μm, and wherein the pores are closed.

39. A method for producing a separating layer for separating the anode and cathode in Li-ion accumulators or batteries, wherein the separating layer has salts conducting Li-ions and ceramic particles, characterised by the following steps: production of a homogeneous, organic solution consisting of polymers or polymer-like substances and solvents, addition of electrolytic salts conducting Li-ions and of ceramic particles, production of a homogeneous slip and conversion of this slip into a thin foil and drying of this foil.

40. A method according to claim 39, wherein in order to produce the organic solution polymers or polymer-like substances are used in a proportion from 0.5% by weight to 30% by weight.

41. A method according to claim 39, wherein electrolytic salts of lithium compounds are added to the organic solution, in consideration of the proportion of ion-conductive polymers or polymer-like substances, with a volume percentage of 10% by volume to 50% by volume, so that the proportion of salts conducting Li-ions and, if applicable, of the ion-conductive polymers or polymer-like substances lies above the percolation threshold.

42. A method according to 39, wherein ceramic powder is added to the organic solution in a proportion of up to 90% by weight.

43. A method according to claim 39, wherein plasticizers are added to the organic solution in a proportion of up to 5% by weight.

44. A method according to claim 39, wherein dispersing agents are added to the organic solution in a proportion of up to 5% by weight.

45. A method according to claim 39, wherein so-called shut-down particles, in particular waxes or low-melting-point polymers, are added to the organic solution in a proportion of up to 30% by weight.

46. A method according to claim 39, wherein the slip is processed to form a foil with a thickness between 20 μm and 30 μm.

47. A method according to claim 39, wherein the foil is dried, as a function of its composition, at temperatures between 60° C. and 120° C. for a period of less than 5 hours.

48. A method according to claim 39, wherein by removing binders from the foil at temperatures between 200° C. and 500° C. over a period of 20 hours to 80 hours the organic constituents are removed from the material of the foil.
